(19) United States
(12) Patent Application Publication
(10) Pub. No.: US 2026/0073461 A1
(43) Pub. Date: Mar. 12, 2026

(54) METHOD, SERVER AND COMPUTER PROGRAM FOR PROVIDING REAL ESTATE RISK-HEDGING CONTRACT SERVICE

(71) Applicant: Jonggu KIM, Seoul (KR)

(72) Inventor: Jonggu KIM, Seoul (KR)

(21) Appl. No.: 19/392,614

(22) Filed: Nov. 18, 2025

Related U.S. Application Data
(63) Continuation of application No. PCT/KR2024/006815, filed on May 20, 2024.

(30) Foreign Application Priority Data
May 18, 2023 (KR) 10-2023-0064450

(51) Int. Cl. G06Q 50/16; G06Q 40/06

(52) U.S. Cl. CPC G06Q 50/16; G06Q 40/06

(57) ABSTRACT

A method, device and computer program for providing a real estate risk hedge agreement service are provided. According to various embodiments of the present disclosure, a method of providing a real estate risk hedge agreement service, which is performed by a server to avoid a risk due to a real estate price fluctuation, includes acquiring a purchase request for a risk hedge agreement product for a real estate property from a user, concluding an electronic contract for the risk hedge agreement product by performing an electronic contract process in response to the acquired purchase request, and extinguishing the concluded electronic contract or performing a sales contract process for the real estate property based on whether the user exercises their rights under the concluded electronic contract.

### CROSS-REFERENCE TO RELATED APPLICATION

This application is a continuation of the International Application No. PCT/KR2024/006815 filed May 20, 2024, which claims priority to and the benefit of Korean Patent Application No. 10-2023-0064450, filed on May 18, 2023, the disclosure of which is incorporated herein by reference in its entirety.

### BACKGROUND

### 1. Field of the Invention

The present disclosure relates to a method, server, and computer program for providing a real estate risk hedge agreement service, and more particularly, to a method, server, and computer program for providing a real estate risk hedge agreement service capable of avoiding risks due to real estate price fluctuations by providing a risk hedge agreement product that can maintain ownership of real estate or sell real estate at a fixed price depending on whether or not a right is exercised.

### 2. Discussion of Related Art

Real estate refers to immovable assets, such as land and the buildings and trees attached to the land. Despite its high price volatility and low liquidity, such real estate has become a major investment target due to its potential as an inflation hedging tool. For example, when inflation occurs while monetary assets such as cash, deposits, and bonds are held, values of those assets will decline by a greater margin than their investment returns, resulting in a loss of purchasing power. However, real assets such as real estate have the advantage of protecting asset value, as their prices tend to rise in line with inflation. Therefore, if real estate serves as an inflation hedge, it would be advantageous to increase its allocation in an investment portfolio, particularly during periods of currency crises, stagflation, high inflation, and similar conditions.

Here, an inflation hedge is generally an asset whose return rate changes in the same direction as the inflation rate or, on average, independently of the inflation rate. When investing in real estate during inflationary periods yields a nominal return rate equal to or greater than the inflation rate, it may mean that real estate serves as a perfect hedge against inflation.

In this case, solutions for hedging risks in financial investments and methods for linking real estate collateral loans and indemnity insurance have been researched and developed. Korean Patent Registration No. 10-1984010 (announced on Sep. 3, 2019) and Korean Patent Publication No. 2010-0055852 (published on May 27, 2010) are related art that discloses a configuration in which an investment-seeking company is registered as a company eligible for investment after a basic screening, the investment-seeking company is set to be converted into equity before the maturity date, and a right is granted to an investor whose loss ratio as of the maturity date exceeds a predetermined amount to purchase shares of another company at a discounted price through a call option, thereby hedging the risk of equity investment, and a configuration in which real estate guaranteed value compensation insurance is automatically applied when a loan product for collateralized real estate is sold, the difference between the remaining loan principal and the auction winning bid amount is hedged through compensation insurance, and the configuration in which setting information is managed, thereby reducing the risk of financial institutions.

However, the former merely discloses a configuration that grants a call option purchase right on the maturity date, and does not provide a configuration for actually hedging losses or damages arising from the investment, and the latter only discloses a configuration having the nature of risk underwriting and B2B reinsurance of insurance, and does not provide a fixed-amount purchase agreement product corresponding to a real estate price fluctuation.

Real estate, which constitutes the representative basic asset for most citizens, is one of the most stable assets in terms of future value; however, when value or price fluctuations occur, real estate also becomes the asset that suffers the greatest impact. Furthermore, in the case of housing subscriptions or newly constructed properties for sale where occupancy occurs after a certain period following purchase, contract cancellations due to personal circumstances that may arise in the future result in increased burdens from penalty fees upon withdrawal. Accordingly, there is a need for research and development of a risk hedge agreement product to mitigate risks arising from real estate price fluctuations and penalties due to buyer's remorse.

### SUMMARY OF THE INVENTION

The problem to be solved by the present disclosure is to overcome the above-described conventional problems. Accordingly, the present disclosure is directed to providing a method, server, and computer program for providing a real estate risk hedge agreement service, in which an electronic contract of a risk hedge agreement product for a real estate property is executed upon a user's request, the electronic contract is extinguished based on whether the user exercises their rights under the electronic contract so that the user maintains ownership of the real estate property, or the user is allowed to sell the real estate property at a predetermined fixed price, thereby avoiding risks arising from real estate price fluctuations.

Objects of the present disclosure are not limited to the above-mentioned objects. That is, other objects that are not mentioned may be obviously understood by those skilled in the art from the following description.

According to an aspect of the present disclosure, there is provided a method of providing a real estate risk hedge agreement service, which is performed by a server, includes acquiring a purchase request for a risk hedge agreement product for a real estate property from a user, concluding an electronic contract for the risk hedge agreement product by performing an electronic contract process in response to the acquired purchase request, and extinguishing the concluded electronic contract or performing a sales contract process for the real estate property based on whether the user exercises their rights under the concluded electronic contract.

The concluding of the electronic contract may include performing a feasibility review process of analyzing information regarding the real estate property and a real estate development project being performed at a business site including the real estate property, determining approval for subscription to the risk hedge agreement product for the real estate property based on business feasibility review results derived from the performed business feasibility review process, when the subscription to the risk hedge agreement product for the real estate property is approved, providing the user with an electronic contract form to execute a contract for the risk hedge agreement product for the real estate property, and concluding the electronic contract for the risk hedge agreement product for the real estate property based on signature information acquired from the user in response to the provided electronic contract form.

The performing of the feasibility review process may include determining whether each of a plurality of households included in a specific business site is eligible to subscribe to the risk hedge agreement product by screening each of the plurality of households based on predefined evaluation fields and evaluation items, and calculating a ratio of the number of households determined to be eligible to subscribe to the risk hedge agreement product to the number of the plurality of households, and determining a risk acceptance rate for the specific business site based on the calculated ratio.

The performing of the business feasibility review process may include calculating a risk acceptance rate of the business site including the real estate property by performing a factor analysis of the real estate development project for the business site including the real estate property based on the predefined evaluation fields and evaluation items, and the determining of the approval for subscription to the risk hedge agreement product may include determining an eligible household or an agreed ratio of the risk hedge agreement product for the business site including the real estate property based on the calculated risk acceptance rate, and approving or rejecting the subscription to the risk hedge agreement product for the real estate property based on the determined eligible household or agreed ratio.

The concluding of the electronic contract of the risk hedge agreement product for the real estate property may include, when acquiring the signature information from the user in response to the provided electronic contract form, providing the user with a payment process of paying a handling fee for the risk hedge agreement product, and the handling fee is determined based on an indicator corresponding to at least one of an acquisition cost, a market price, an exercise price of the real estate property, a remaining period until the expiration of the concluded electronic contract, price volatility, and market conditions.

The concluding of the electronic contract may include when the business site including the real estate property is a previously approved business site, providing the user with an electronic contract form for contract of the risk hedge agreement product for the real estate property, and when the business site including the real estate property is a new business site, providing the user with the electronic contract form for the contract of the risk hedge agreement product for the real estate property only when the subscription to the risk hedge agreement product for the real estate property is approved through a business feasibility review process.

The extinguishing of the concluded electronic contract or the performing of the sales contract process for the real estate property may include performing a real estate purchase contract process of purchasing the real estate property at a predetermined exercise price when the user exercises their rights regarding the concluded electronic contract within a predetermined period after an expiration of a mandatory commitment period under the concluded electronic contract.

The extinguishing of the concluded electronic contract or the performing of the sales contract process for the real estate property may include extinguishing the concluded electronic contract and terminating the contract under the electronic contract corresponding to the concluded electronic contract when the user does not exercise their rights to the concluded electronic contract within a predetermined period after an expiration of a mandatory commitment period under the concluded electronic contract.

The method of providing a real estate risk hedge agreement service may further include, when a business operator requests risk hedge agreement consulting for a real estate development project performed at a specific business site, performing a business feasibility review process of deriving business feasibility review results including a risk acceptance rate for the real estate development project performed at the specific business site, the risk acceptance rate being a ratio of the number of eligible households of the risk hedge agreement product to a total number of households supplied at the specific business site, and providing the derived business feasibility review results to the business operator or the user.

According to another aspect of the present disclosure, there is provided, a server for performing a method of providing a real estate risk hedge agreement service includes a processor, a network interface, a memory, and a computer program loaded into the memory and executed by the processor, in which the computer program includes an instruction to acquire a purchase request for a risk hedge agreement product for a real estate property from a user, an instruction to conclude an electronic contract for the risk hedge agreement product by performing an electronic contract process in response to the acquired purchase request, and an instruction to extinguish the concluded electronic contract or perform a sales contract process for the real estate property based on whether the user exercises their rights under the concluded electronic contract.

According to still another aspect of the present disclosure, there is provided, there is provided a computer program stored in a computer-readable recording medium, which is coupled with a server to execute a method of providing a real estate risk hedge agreement service, in which the method includes acquiring a purchase request for a risk hedge agreement product for a real estate property from a user, concluding an electronic contract for the risk hedge agreement product by performing an electronic contract process in response to the acquired purchase request, and extinguishing the concluded electronic contract or performing a sales contract process for the real estate property based on whether the user exercises their rights under the concluded electronic contract.

Other specific details of the invention are included in the detailed description and drawings.

### BRIEF DESCRIPTION OF DRAWINGS

FIG. 1 is a diagram illustrating a system for providing a real estate risk hedge agreement service according to one embodiment of the present disclosure.

FIG. 2 is a diagram illustrating the hardware configuration of a server for providing a real estate risk hedge agreement service according to another embodiment of the present disclosure.

FIG. 3 is a flowchart illustrating a method of providing a risk hedge agreement service for real estate property within an unapproved business site to a user in various embodiments.

FIG. 4 is a diagram illustrating exemplary types of risk hedge agreement products applicable to various embodiments.

FIGS. 5 to 7 are diagrams illustrating a process (B2C) for providing a real estate risk hedge agreement service to a user in various embodiments.

FIG. 8 is a flowchart illustrating a method of providing a risk hedge agreement service for real estate property within a previously approved business site to a user in various embodiments.

FIG. 9 is a flowchart illustrating a method of providing a real estate risk hedge agreement service to a company in various embodiments.

FIG. 10 is a diagram illustrating a process (B2B) for providing real estate risk hedge agreement services to a company in various embodiments.

FIGS. 11 to 15 are diagrams illustrating a user interface (UI) for providing a real estate risk hedge agreement service in various embodiments.

### DETAILED DESCRIPTION OF EXEMPLARY EMBODIMENTS

Advantages and features of the present disclosure and methods to achieve them will be elucidated from embodiments described below in detail with reference to the accompanying drawings. However, the present disclosure is not limited to embodiments to be described below, but may be implemented in various different forms, these embodiments will be provided only in order to make the present disclosure complete and allow those skilled in the art to completely recognize the scope of the present disclosure, and the present disclosure will be defined by the scope of the claims.

Terms used in the present specification are for explaining embodiments rather than limiting the present disclosure. Unless otherwise stated, a singular form includes a plural form in the present specification. Throughout this specification, the term “comprise” and/or “comprising” will be understood to imply the inclusion of stated constituents but not the exclusion of any other constituents. Like reference numerals refer to like components throughout the specification and “and/or” includes each of the components mentioned and includes all combinations thereof. Although “first,” “second,” and the like are used to describe various components, it goes without saying that these components are not limited by these terms. These terms are used only to distinguish one component from other components. Therefore, it goes without saying that a first component mentioned below may be a second component within the technical scope of the present disclosure.

Unless defined otherwise, all terms (including technical and scientific terms) used in the present specification have the same meanings commonly understood by those skilled in the art to which the present disclosure pertains. In addition, terms defined in commonly used dictionary are not ideally or excessively interpreted unless explicitly defined otherwise.

The term “unit” or “module” used in the specification refers to a software component or a hardware component such as a field-programmable gate array (FPGA) or application-specific integrated circuit (ASIC), and the “unit” or “module” performs certain roles. However, the term “unit” or “module” is not intended to be limited to software or hardware. A “unit” or “module” may be configured to be stored in a storage medium that can be addressed or may be configured to regenerate one or more processors. Accordingly, for example, a “unit” or “module” includes components such as software components, object-oriented software components, class components, and task components, processors, functions, attributes, procedures, subroutines, segments of a program code, drivers, firmware, a microcode, a circuit, data, a database, data structures, tables, arrays, and variables. Functions provided in components, “units,” or “modules” may be combined into fewer components, “units,” or “modules” or further separated into additional components, “units,” or “modules.”

Spatially relative terms “below,” “beneath,” “lower,” “above,” “upper,” and the like may be used to easily describe the correlation between one component and other components as illustrated in drawings. The spatially relative terms should be understood as terms including different directions of components during use or operation in addition to the directions illustrated in the drawings. For example, when components illustrated in the drawings are turned over, a component described as “below” or “beneath” another component may be placed “above” the other component. Therefore, the illustrative term “below” can include both downward and upward directions. The components can also be aligned in different directions, and therefore the spatially relative terms can be interpreted according to the alignment.

In this specification, the computer is any kind of hardware device including at least one processor and can be understood as including a software configuration which is operated in the corresponding hardware device according to the embodiment. Examples of the computer may be understood to include all of smart phones, tablet PCs, desktops, notebooks, and user clients and applications running on each device, but is not limited thereto.

Hereinafter, embodiments of the present disclosure will be described in detail with reference to the accompanying drawings.

Each step described in the present disclosure is described as being performed by a computer, but subjects of each step are not limited thereto, and according to embodiments, at least some of each step can also be performed on different devices.

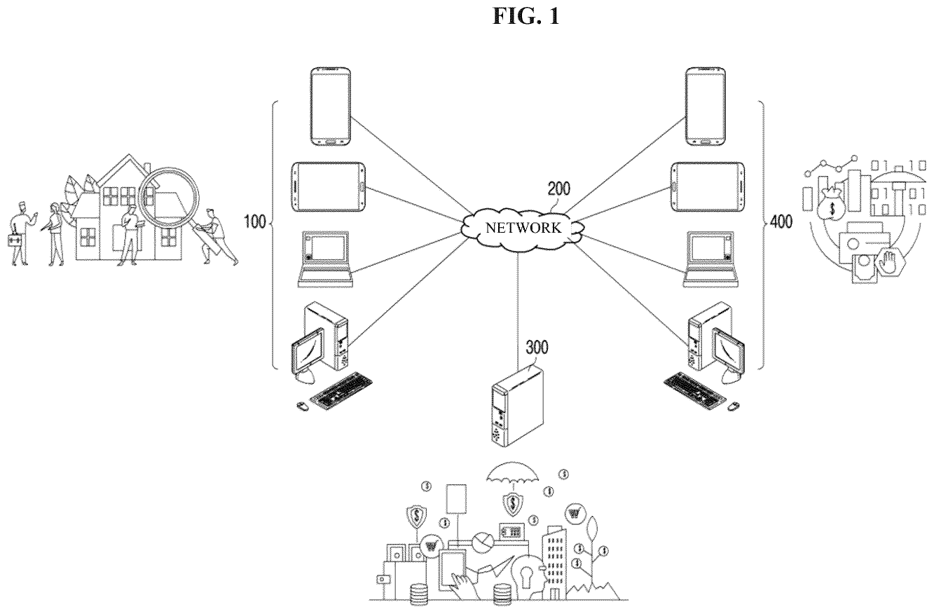

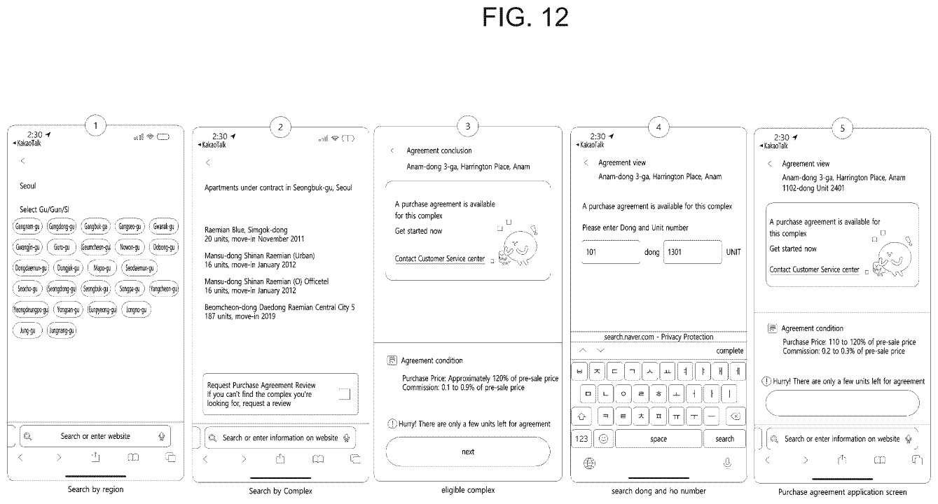

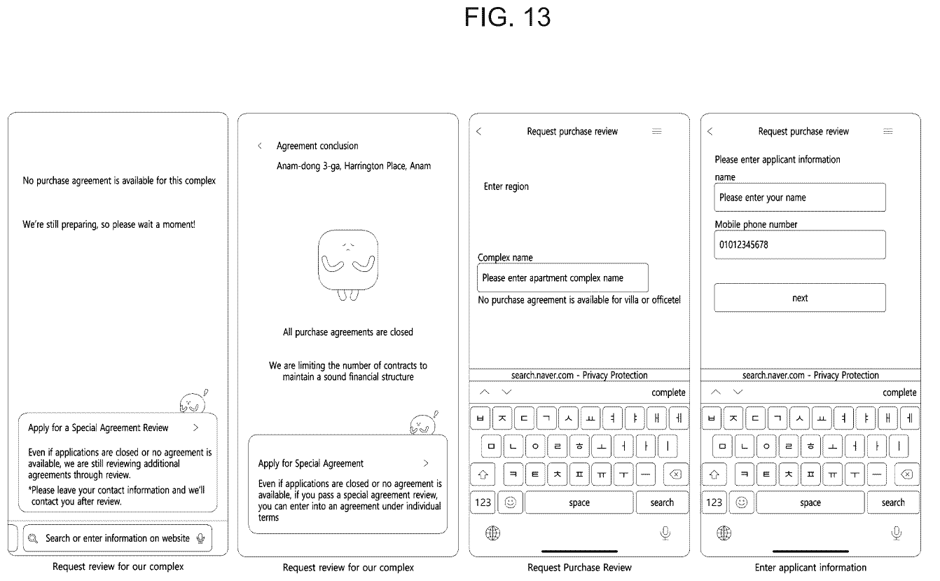

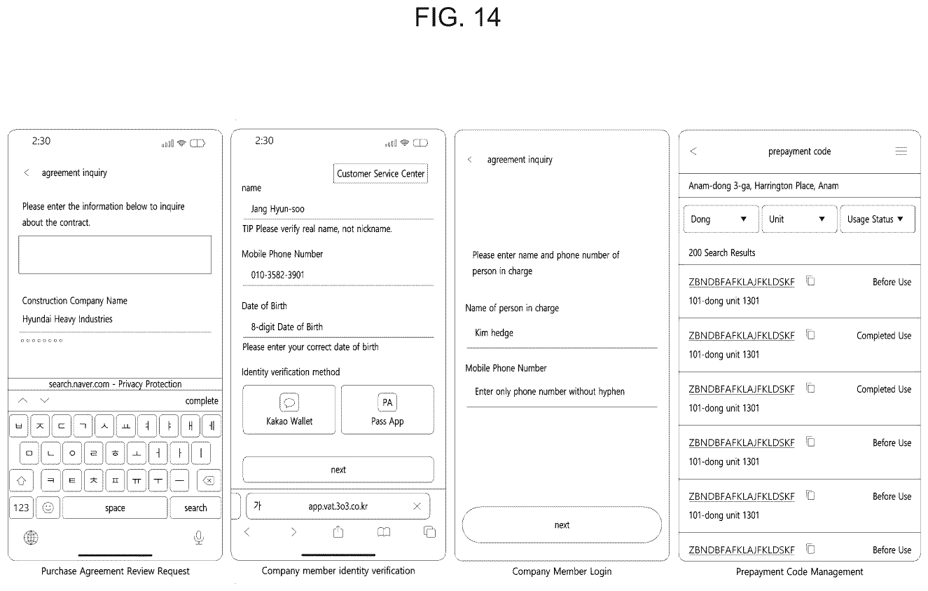

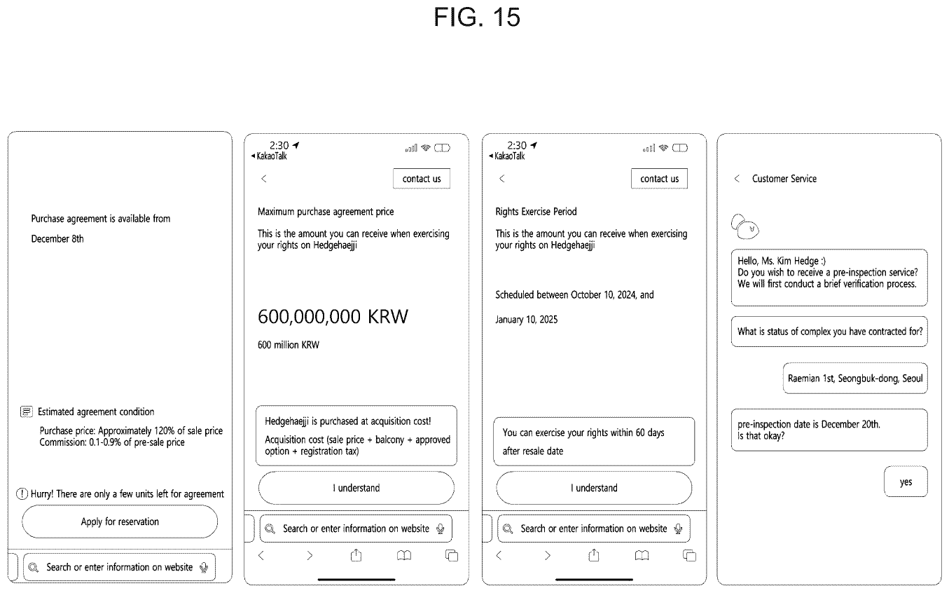

Before describing a method of providing a real estate risk hedge agreement service according to various embodiments of the present disclosure with reference to FIGS. 1 to 15, the basic concepts necessary to understand the various embodiments of the present disclosure will be first described.

### <Hedge>

A hedge is defined based on how the prices of two assets considered as investment targets are related under specific market conditions. It refers to an asset whose price is typically unrelated to or moves in the opposite direction from other assets or portfolios.

Since the hedge is a concept applied during normal asset market periods, in times of market instability and turmoil, such as during financial crises or periods of speculation, the prices of the asset and the hedged asset may move in the same direction, thereby failing to provide a risk avoidance function.

While the hedge is primarily defined and studied for investment products, it may also be specifically defined in relation to inflation. Inflation is the decline in the value of monetary assets. Therefore, for an inflation hedge to be effective, the nominal return rate of the asset should move in the same direction as or be independent of the inflation rate. The nominal return rate of the normal, which moves in the same direction as the inflation rate, is sometimes called a strong hedge, while the nominal return rate that is independent of the inflation rate is sometimes called a weak hedge.

### <Derivatives>

Derivatives are financial instruments whose prices are determined by fluctuations in the value of an underlying asset, typically based on traditional financial instruments such as stocks and bonds. Representative examples include \textcircled{1} option contracts, which are rights-based instruments, \textcircled{2} forward contracts, which are promise-based instruments, and \textcircled{3} futures contracts.

First, \textcircled{1} the options contracts grant a holder of a long position the right to buy (call option) or sell (put option) the asset at a specific price within a specific period of time. The opposite position, i.e., a holder of a short position, has the obligation to fulfill the contract. Options come in various types, each with different payoffs, allowing traders to hedge market risk through appropriate options trading.

Next, \textcircled{2} the forward contract is a bilateral contract that promises to deliver a specific amount of an asset at a specific price at a certain point in the future. The buyer agrees to purchase the asset at a specific price at a specific time, and the seller agrees to deliver the asset at a fixed price at the specified time. The forward trading primarily occurs over-the-counter (OTC) and is not standardized, allowing for relatively free trading.

Finally, \textcircled{3} the futures contract is a legally binding contract in which the quality, quantity, delivery time, delivery location, price disclosure, minimum bid size, and daily fluctuation range of the asset are standardized for each product. The futures trading is similar in nature to forward trading, but the main differences are that it is standardized and conducted on an exchange.

Through this derivatives trading, hedgers may reduce, hedge, and manage financial and market risks. The futures trading includes a wide range of assets, from agricultural products to stock market indices. Because most futures trading is not for the actual delivery of a commodity but rather to hedge against price fluctuations, futures positions are either closed before the payment date without delivery of the asset or are closed through an opposite position.

### <Hedging>

Hedging is one of the key functions of the futures market. It is a technique for managing market risk, which may not be reduced through diversified investments, through derivatives and external financing techniques. Investors with a long position in a spot asset may hedge market risk by taking a short position in the futures market or purchasing a put option. Conversely, investors with a short position in a spot asset may hedge market risk by taking a long position in the futures market or purchasing a call option.

Hedging strategies may be broadly categorized into \textcircled{1} a short hedge and \textcircled{2} a long hedge.

First, a short hedge occurs when a hedger with a long spot position takes a short position in a futures contract to mitigate the risk of a price decline. While a price decline incurs a loss on the spot position, the futures position generates a corresponding gain to effectively offset the loss and profit, thereby mitigating the risk of a price decline. Therefore, the short hedge is an appropriate hedging strategy when a hedger holds a long spot position and anticipates a price decline.

Next, a long hedge occurs when an investor with a short spot position takes a long position in the futures market to hedge against price fluctuation risk. Therefore, the long hedge is an appropriate hedging strategy when a hedger holds a short spot position and anticipates a price increase.

While hedging is a useful strategy for managing price fluctuation and market risk, it also has the disadvantage of reducing potential future returns. For example, even if a hedge was implemented to avoid price fluctuation risk, this hedging strategy results in the same outcome as forgoing the greater profits that could be acquired had the hedging strategy not been implemented. However, from a risk management perspective, even the greatest potential profits are less important than managing the risk of catastrophic consequences within appropriate limits. Therefore, hedging is an essential risk management technique in investment trading that requires stability.

Considering this, various embodiments of the present disclosure provide a risk hedging agreement service to hedge the risk associated with real estate price fluctuations. From a risk management perspective, no matter how great the potential profit may be, it is not more important than managing catastrophic risks within an appropriate limit. Hereinafter, with reference to FIGS. 1 to 15, the method of providing a real estate risk hedge agreement service according to various embodiments of the present disclosure will be described.

FIG. 1 is a diagram illustrating the system for providing a real estate risk hedge agreement service according to one embodiment of the present disclosure.

Referring to FIG. 1, the system for providing a real estate risk hedge agreement service according to one embodiment of the present disclosure may include a user terminal 100, a network 200, a server 300, and a business operator terminal 400.

Here, the system for providing a real estate risk hedge agreement service illustrated in FIG. 1 is an example, and its components are not limited to the embodiment illustrated in FIG. 1, and may be added, modified, or deleted as needed.

For example, the system for providing a real estate risk hedge agreement service according to another embodiment of the present disclosure may further include a storage server separately installed outside of the server 300 that stores and manages various information and data necessary for the server 300 to provide the real estate risk hedge agreement service, or that collects, stores, and manages various information and data generated as the server 300 provides the real estate risk hedge agreement service. However, the present disclosure is not limited thereto.

In one embodiment, the user terminal 100 may be connected to the server 300 via the network 200 and may receive the real estate risk hedge agreement service from the server 300. For example, the real estate risk hedge agreement service provided by the server 300 may be implemented in the form of a web page, an app page, a program, or an application, and a user may use the real estate risk hedge agreement service provided by the server 300 by executing the web page, app page, program, or application via the user terminal 100.

Here, the user terminal 100 may be a terminal of someone such as a purchaser, a real estate seller, or a pre-sale right holder who purchases or optionally selects a real estate risk hedge agreement product. For example, a user who wishes to use the real estate risk hedge agreement service provided by the server 300 may pay a handling fee for purchasing a risk hedge agreement product through his/her user terminal 100 and sign the electronic contract form provided by the server 300 to conclude the electronic contract. In addition, after the mandatory commitment period of the risk hedge agreement product has elapsed, a user who has concluded the electronic contract for the risk hedge agreement product may transfer the ownership of the real estate property by selling the real estate property at a preset price by exercising the right under the electronic contract through the user terminal 100, and may maintain the ownership of the real estate property by not exercising the right under the electronic contract.

In various embodiments, the user terminal 100 may be any form of entity(ies) in a system having a mechanism for communicating with the server 300. For example, the user terminal 100 may include a personal computer (PC), a notebook, a mobile terminal, a smart phone, a tablet PC, a wearable device, etc., and may include all types of terminals capable of connecting to wired/wireless networks. In addition, the user terminal 100 may include any computing device implemented by at least one of an agent, an application programming interface (API), and a plug-in. In addition, the user terminal 100 may include application sources and/or client applications.

Here, the network 200 may be a connection structure capable of exchanging information between respective nodes such as a plurality of terminals and servers. For example, the network 200 may include a local area network (LAN), a wide area network (WAN), the Internet (World Wide Web (WWW)), a wired/wireless data communication network, a telephone network, a wired/wireless television communication network, or the like.

Examples of the wireless data communication network may include 3^{rd} generation (3G), 4th generation (4G), 5th generation (5G), 3^{rd} Generation Partnership Project (3GPP), 5th Generation Partnership Project (5GPP), Long Term Evolution (LTE), World Interoperability for Microwave Access (WiMAX), Wi-Fi, the Internet, a LAN, a wireless LAN (WLAN), a WAN, a personal area network (PAN), radio frequency, a Bluetooth network, a near-field communication (NFC) network, a satellite broadcast network, an analog broadcast network, a digital multimedia broadcasting (DMB) network, and the like, but are not limited thereto.

In one embodiment, the server 300 may provide the real estate risk hedge agreement service implemented as the web page, app page, program, or application.

Here, the real estate risk hedge agreement service provided by the server 300 may be a service in which the risk hedge agreement product is sold, but is not limited thereto. For example, the server 300 may acquire a purchase request for the risk hedge agreement product from a user via the user terminal 100, and upon payment of a fee (e.g., a handling fee) for subscribing to the risk hedge agreement product, execute the electronic contract process of concluding the electronic contract for the risk hedge agreement product. Furthermore, after the mandatory commitment period for the risk hedge agreement product has elapsed, the server 300 may purchase real estate property at a preset price when the user who has entered into the electronic contract for the risk hedge agreement product exercises their rights under the electronic contract. When the user does not exercise their rights under the electronic contract, the server may terminate the electronic contract, thereby terminating the contract. To this end, the server 300 may perform the reception process, the transmission process, the receipt process, the storage process, the purchase project process, the profit-making business process, and the contract termination process.

First, by performing the reception process, the server 300 may receive a request to purchase the risk hedge agreement product for the real estate property (or a request to hedge risk for real estate property) from the user terminal 100.

Next, by performing the transmission process, the server 300 may upload business feasibility review results for a business site including real estate property. When subscription to the risk hedge agreement product for the real estate property is approved based on the business feasibility review results, the server 300 may generate an electronic contract form for the risk hedge agreement product contract and transmit the generated electronic contract form to the user terminal 100.

Next, by performing the receipt process, the server 300 may acquire a signature on the electronic contract form transmitted to the user terminal 100 and collect payment of a handling fee for concluding the electronic contract. In this case, the server 300 may further perform a user authentication process of verifying the identity of the user entering into the electronic contract.

Here, the identity authentication process performed by the server 300 may be performed based on various ID cross-validation methods, such as facial recognition, but is not limited thereto. When acquiring the signature on the electronic contract form from a user, the server 300 may verify whether the signature is signed directly by the user or whether the signature is forged.

More specifically, considering that each individual has unique handwriting, the server 300 may determine the authenticity of the electronic signature by analyzing the strokes, such as the force, acceleration, and shape of each stroke. For example, when an electronic signature is signed using a stylus pen, sensor data may be collected via sensors (e.g., acceleration and gyro sensors) built into the stylus pen. The measured values are acceleration and angular velocity along each axis during signing, which may be integrated to acquire velocity and displacement. In this case, the server 300 may perform a preprocessing process by applying a Kalman filter, which is used for object tracking or noise removal, to correct errors in sensor data, and may use the resulting values as data for the signature. The signature information generated through this process may be converted into an image, and information about the pen used for signing (device ID, location information, etc.) may also be transmitted.

Here, the server 300 may recognize the user's signature based on a convolutional neural network. More specifically, the server 300 uses the signature image received from the user terminal 100 and the imaged data collected from the stylus pen as input data for the convolutional neural network. A filter traverses the image to extract and learn features based on the input data and classifies the image. In this case, the classified class name is the identifier of the user who signed the electronic contract form. The input data input to the convolutional neural network may be stored and used when the next electronic contract form is used.

The validity of the signature is determined by comparing the device ID of the stylus pen used for signing with the device ID of a pre-registered stylus pen. The validity of the signature is determined when classified data of both is recognized as the signature of the same user. In this case, the server 300 may determine that the validity of the signature has not been verified when signature data is not collected from a previously registered stylus pen, when the stylus pen exists but the signature image is different, or when the stylus pen exists and the signature image is similar or identical but the signature features, including strokes, order, and acceleration, are different. However, this is not limited thereto.

Next, the server 300 may store the electronic contract of the risk hedge agreement product form concluded with the user by performing the storage process. The server 300 may store the electronic contract form until the contract expiration date. Here, the server 300 may configure a blockchain for storage and store the blockchain in a distributed manner. The accessible nodes may be configured as Hyperledger blockchains among private blockchains comprised of those who have entered into the electronic contract of the present disclosure, thereby eliminating the possibility of forgery and ensuring integrity. In this case, since uploading the image itself for each electronic contract form incurs excessive gas fee charges, the server 300 may store content such as images in the InterPlanetary file system (IPFS) and store trading by creating blocks for only the data values.

Next, when the user exercises their rights under the electronic contract, the server 300 may perform a purchase project process of purchasing the user's real estate property at a preset price. Furthermore, when the server 300 performs a profit-making business process, it may provide information on previously purchased real estate properties. When a lease or sale of a previously purchased real estate property is requested, it may provide an environment for concluding a lease agreement or sale and purchase agreement (e.g., matching with a licensed real estate agent and completing a lease agreement form/sale and purchase agreement form).

Next, when the user does not exercise their rights under the electronic contract, the server 300 may terminate the electronic contract form by performing a contract termination process of terminating the concluded electronic contract with the user.

In various embodiments, the server 300 may provide a business feasibility review service for a real estate development project being performed at a business site. For example, the server 300 may perform the business feasibility review for the real estate development project being performed at a specific business site based on a request from a business operator acquired through a business operator terminal 400, and may generate a report or letter of intent for handling containing the resulting risk acceptance rate and provide the report to the business operator terminal 400. To this end, the server 300 may include a consulting process, a development management process, a proportional setting process, a payment management process, and a forecasting process.

First, when a business operator requests consulting on the use of a risk hedge agreement product for the real estate development project, the server 300 may collect a consulting fee by performing the consulting process, upload business feasibility review results for the real estate development project, and provide a business feasibility review report including a risk acceptance rate for the real estate development project to the business operator terminal 400.

Next, when at least one user terminal 100 subscribes to the risk hedge agreement product based on the business feasibility review report for the real estate development project of the business operator terminal 400, the server 300 may perform the development management process, transmit an electronic contract form for a contract for the risk hedge agreement product to at least one user terminal 100 based on the business feasibility review report, and acquire a signature from at least one user terminal 100 and store the electronic contract form.

Next, the server 300 may set the number of subscribers, agreed ratio, handling fee rate, fair agreement price, etc., of the risk hedge agreement product based on the risk acceptance rate by performing the proportional setting process. For example, a linear regression analysis may be performed using the risk premium as the dependent variable in the first model, the residual of the first model as the dependent variable in the second model, and the residual of the second model as the dependent variable in the third model. Here, the residual may refer to the difference between the actual risk premium value and the predicted premium value. In other words, the residual of the first model may be used as the dependent variable of the second model, and the residual of the second model may be used as the dependent variable of the third model.

The dependent variable called the risk premium may be expressed in different ways for each participant, but it does not differ significantly from the perspective of compensation or reward for risk burden. For example, from a project developer's perspective, it may be applied to the internal rate of return (IRR) for equity investment, the expected rate of return for project execution, the business return rate (which acts as a buffer or cushion for the possibility of principal and interest repayment) from a financial institution, and the guarantee fee rate, which is the compensation for the risk associated with providing a guarantee from a guarantor. The risk premium is defined as the difference between the required rate of return for risky investment assets and the required rate of return for risk-free assets. The higher the risk, the higher the required rate of return for investment assets, due to the trade-off between return rate and risk. In short, the risk premium may be viewed as compensation for an investor's risk-bearing.

The risk premium for each concept used as a dependent variable is calculated by subtracting the risk-free rate of return and the reference guarantee fee rate from the equity IRR, project expected return, and guarantee fee rate. In particular, the equity IRR is a value calculated by recognizing the equity capital initially invested by the project developer and the business profit earned upon completion. The equity IRR may be derived by calculating the equity investment amount, the equity recovery amount after the project period, and the business profit (sales-operating expenses) for each individual project. As described above, the risk premium is a form of expected return that is derived from assuming risk. In other words, the risk premium may be defined as the expected rate of return of risky investment assets minus the risk-free asset return rate. In other words, the greater the risk, the higher the risk premium becomes, which in turn increases the expected rate of return on investment assets, and it can be defined as in the following Equation 1.

$$\begin{matrix}{k}_{o}^{L} = {k}_{e}^{L} \frac{S}{V} + {k}_{d}^{L} \frac{B}{V} \\ {k}_{e}^{L} = {R}_{f} + [ E ( {R}_{m} ) - {R}_{f} ] \times {B}_{s}^{L}\end{matrix} \qquad < Equation 1 >$$

Here, K^{L}o denotes the weighted average cost of capital, k^{L}e denotes the cost of equity capital, Rf denotes the risk-free rate of return, S denotes capital, B denotes debt, V denotes asset value, E(Rm) denotes the market rate of return, kd denotes the cost of debt capital, and B^{L}s denotes risk. The greater the risk of an asset or company with debt, the greater the risk premium, which in turn increases the cost of equity capital. Furthermore, an increase in the cost of equity capital increases the weighted average cost of capital. Factors affecting the risk premium may include operational risk, financial risk, etc., and since these risks affect the risk premium and return rate, the handling fee may be calculated in consideration of these factors.

Next, the server 300 may receive the handling fee for the risk hedge agreement product from the business operator terminal 400 or the user terminal 100 as the server 300 performs the payment management process.

Finally, the server 300 may provide a predicted price based on the maturity date of the risk hedge agreement product using an artificial intelligence algorithm when conducting a business feasibility review for the real estate property as the server 300 performs the prediction process.

In various embodiments, the server 300 may use a pre-trained artificial intelligence model to predict a housing price index and provide it to a business feasibility reviewer (e.g., an employee of the platform of the present disclosure) to assist in decision-making when deciding whether to approve a request.

Here, the artificial intelligence model (e.g., neural network) is composed of one or more network functions, and the one or more network functions may be composed of a set of interconnected computational units that may generally be referred to as “nodes.” These “nodes” may also be referred to as “neurons.” One or more network functions are configured to include one or more nodes. The nodes (or neurons) that constitute one or more network functions may be interconnected by one or more “links.”

Within the artificial intelligence model, one or more nodes connected via links may form the relative relationships between input nodes and output nodes. The concepts of the input nodes and the output nodes are relative, meaning that any node in an output node relationship with one node may also be in an input node relationship with another node, and vice versa. As described above, the relationships between the input nodes and the output nodes may be generated around the links. One input node may be connected to one or more output nodes via the links, and vice versa.

In the relationship between the input node and the output node connected via a single link, the value of the output node may be determined based on the data input to the input node. Here, the node interconnecting the input node and the output node may have a weight. Weights may be variable and may be adjusted by the user or algorithm to allow the AI model to perform its desired function. For example, when one or more input nodes are interconnected to an output node via individual links, the output node may determine its output node value based on the values input to the input nodes connected to the output node and the weights assigned to the links corresponding to each input node.

As described above, the artificial intelligence model forms an input-output node relationship within the model by interconnecting one or more nodes through one or more links. The characteristics of the AI model may be determined based on the numbers of nodes and links, the relationships between nodes and links, and the weights assigned to each link. For example, when two AI models exist with the same number of nodes and links but different weight values between the links, the two AI models may be perceived as different from each other.

Some of the nodes constituting the artificial intelligence model may constitute one layer based on their distances from an initial input node. For example, a set of nodes that are a distance n from the initial input node may constitute n layers. The distance from the initial input node may be defined by the minimum number of links required to reach the corresponding node from the initial input node. However, this definition of the layer is arbitrary for illustrative purposes, and the number of the layer within the artificial intelligence model may be defined in a different manner than described above. For example, the layer of nodes may be defined by a distance from a final output node.

The initial input node may be one or more nodes within the artificial intelligence model that receive data directly without passing through links in relationships with other nodes. Alternatively, within the artificial intelligence model network, the node may be nodes that do not have other input nodes connected by a link, in a relationship between nodes based on a link. Similarly, the final output node may be one or more nodes that do not have output nodes in a relationship with other nodes within the artificial intelligence model. In addition, the hidden nodes may be nodes that constitute the AI model other than the initial input node and the final output node. According to one embodiment of the present disclosure, the AI model may have more nodes in the input layer than in the hidden layer closer to the output layer, and the number of nodes may decrease as the model progresses from the input layer to the hidden layer.

The AI model may include one or more hidden layers. The hidden nodes in the hidden layer may receive the output of the previous layer and the output of surrounding hidden nodes as an input. The number of hidden nodes in each hidden layer may be the same or different. The number of nodes in the input layer may be determined based on the number of data fields in the input data and may be the same as or different from the number of hidden nodes. The input data input to the input layer may be computed by the hidden nodes in the hidden layer and output by a fully connected layer (FCL), which is the output layer.

In various embodiments, the AI model may be a deep learning model.

A deep learning model (e.g., deep neural network (DNN)) may be an artificial intelligence model including a plurality of hidden layers in addition to an input layer and an output layer. It is possible to identify latent structures of data by using the DNN. That is, it is possible to identify the latent structures (e.g., what objects are in the photo, what the content and emotion of the text are, what the content and emotion of the audio are, etc.) of a photo, text, video, sound, or music.

The DNN may include a convolutional neural network (CNN), a recurrent neural network (RNN), an auto encoder, generative adversarial networks (GAN), a restricted Boltzmann machine (RBM), a deep belief network (DBN), a Q network, a U network, a Siamese network, and the like, but is not limited thereto.

In various embodiments, the network function may include the autoencoder. Here, the autoencoder may be a type of artificial neural network that outputs the output data similar to the input data.

The autoencoder may include at least one hidden layer, and an odd number of hidden layers may be arranged between the input and output layers. The number of nodes in each layer may be reduced from the number of nodes in the input layer to an intermediate layer called a bottleneck layer (encoding) and then expanded symmetrically from the bottleneck layer to the output layer (symmetrical to the input layer). The nodes in the dimensionality reduction layer and the dimensionality restoration layer may or may not be symmetrical. In addition, the autoencoder may perform nonlinear dimensionality reduction. The number of input and output layers may correspond to the number of sensors remaining after preprocessing the input data. In the autoencoder structure, the number of nodes in the hidden layer included in the encoder may have a structure that decreases as it moves away from the input layer. When the number of nodes in the bottleneck layer (the layer with the fewest nodes located between the encoder and the decoder) is too small, a sufficient amount of information may not be transmitted, and therefore the number of nodes may also be maintained at a certain number or more (e.g., more than half of the number of nodes in the input layer, etc.).

In one embodiment, a business operator terminal 400 may be connected to the server 300 via the network 200 and may utilize the real estate risk hedge agreement service provided by the server 300 through the web page, app page, program, or application provided by the server 300.

Here, a business operator may be a user conducting the real estate development project at a specific business site. For example, a business operator wishing to utilize the real estate risk hedge agreement service provided by the server 300 may request consulting on the real estate development project from the server 300 via his or her business operator terminal 400. In response, the server 300 may conduct the business feasibility review for the real estate development project and provide business feasibility review results derived from the review.

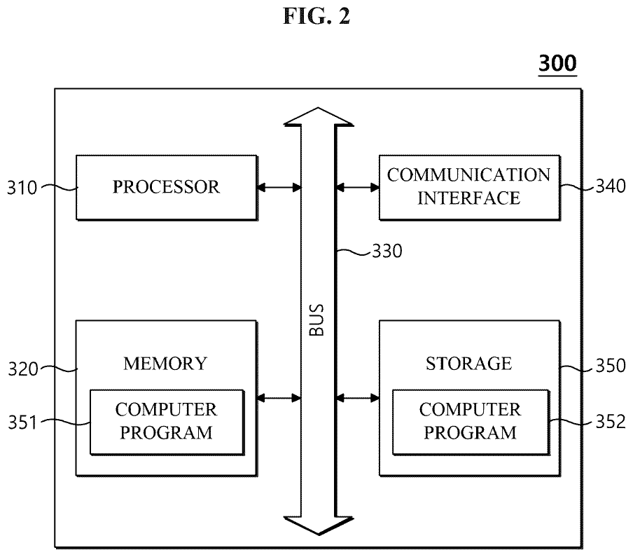

In various embodiments, like the user terminal 100, the business operator terminal 400 may be any entity(ies) in a system that has a mechanism for communicating with the server 300. However, this is not limited thereto. Hereinafter, with reference to FIG. 2, the hardware configuration of a server for providing the real estate risk hedge agreement service will be described.

FIG. 2 is a diagram illustrating the hardware configuration of a server for providing the real estate risk hedge agreement service according to another embodiment of the present disclosure.

Referring to FIG. 2, in various embodiments, the server 300 may include one or more processors 310, a memory 320 for loading a computer program 351 executed by the processors 310, a bus 330, a communication interface 340, and storage 350 for storing the computer program 351. Only components related to the embodiments of the present disclosure are illustrated in FIG. 2. Therefore, those skilled in the art will appreciate that other general-purpose components may be included in addition to the components illustrated in FIG. 2.

The processor 310 controls an overall operation of each component of the server 300. The processor 310 may be configured to include a central processing unit (CPU), a micro processor unit (MPU), a micro controller unit (MCU), a graphics processing unit (GPU), or any type of processor well known in the art of the present disclosure.

In addition, the processor 310 may perform an operation on at least one application or program for executing the method according to the embodiments of the present disclosure, and the server 300 may include one or more processors.

According to various embodiments, the processor 310 may further include a random access memory (RAM) (not illustrated) and a read-only memory (ROM) for temporarily and/or permanently storing signals (or data) processed in the processor 310. In addition, the processor 310 may be implemented in the form of a system-on-chip (SoC) including at least one of a GPU, a RAM, and a ROM.

The memory 320 stores various types of data, commands and/or information. The memory 320 may load the computer program 351 from the storage 350 to execute methods/operations according to various embodiments of the present disclosure. When the computer program 351 is loaded into the memory 320, the processor 310 may perform the method/operation by executing one or more instructions constituting the computer program 351. The memory 320 may be implemented as a volatile memory such as a RAM, but the technical scope of the present disclosure is not limited thereto.

The bus 330 provides a communication function between the components of the server 300. The bus 330 may be implemented as various types of buses, such as an address bus, a data bus, and a control bus.

The communication interface 340 supports wired/wireless Internet communication of the server 300. In addition, the communication interface 340 may support various communication methods other than Internet communication. To this end, the communication interface 340 may be configured to include a communication module well known in the art of the present disclosure. In some embodiments, the communication interface 340 may be omitted.

The storage 350 may non-temporarily store the computer program 351. When performing the process of providing the real estate risk hedge agreement service through the server 300, the storage 350 can store various pieces of information necessary to provide the process of providing the real estate risk hedge agreement service.

The storage 350 may include a nonvolatile memory, such as a ROM, an erasable programmable ROM (EPROM), an electrically erasable programmable ROM (EEPROM), and a flash memory, a hard disk, a removable disk, or any well-known computer-readable recording medium in the art to which the present disclosure pertains.

The computer program 351 may include one or more instructions to cause the processor 310 to perform methods/operations according to various embodiments of the present disclosure when loaded into the memory 320. That is, the processor 310 may perform the method/operation according to various embodiments of the present disclosure by executing the one or more instructions.

In one embodiment, the computer program 351 may include one or more instructions for performing the method of providing the real estate risk hedge agreement service, including the operations of acquiring a purchase request for a hedge agreement product for real estate property from a user, executing an electronic contract process in response to the acquired purchase request to conclude the electronic contract of risk hedge agreement product, and extinguishing the concluded electronic contract or performing a sales contract process for real estate property based on whether the user exercises his or her right to the concluded electronic contract.

Operations of the method or algorithm described with reference to the embodiment of the present disclosure may be directly implemented in hardware, in software modules executed by hardware, or in a combination thereof. The software module may reside in a RAM, a ROM, an EPROM, an EEPROM, a flash memory, a hard disk, a removable disk, a compact disc ROM (CD-ROM), or in any form of computer-readable recording medium known in the art to which the invention pertains.

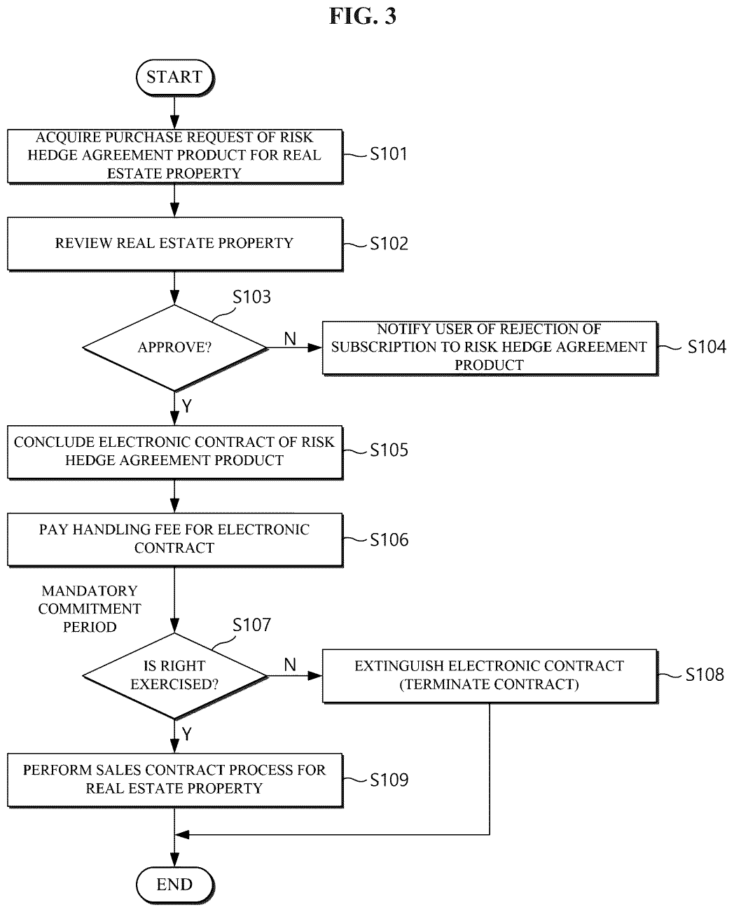

The components of the present disclosure may be embodied as a program (or application) and stored in a medium for execution in combination with a computer which is hardware. The components of the present disclosure may be executed in software programming or software elements, and similarly, embodiments may be realized in a programming or scripting language such as C, C++, Java, and an assembler, including various algorithms implemented in a combination of data structures, processes, routines, or other programming constructions. Functional aspects may be implemented in algorithms executed on one or more processors. Hereinafter, a description will be given of a method of providing a real estate risk hedge agreement service performed by the server 300 with reference to FIGS. 3 to 10.

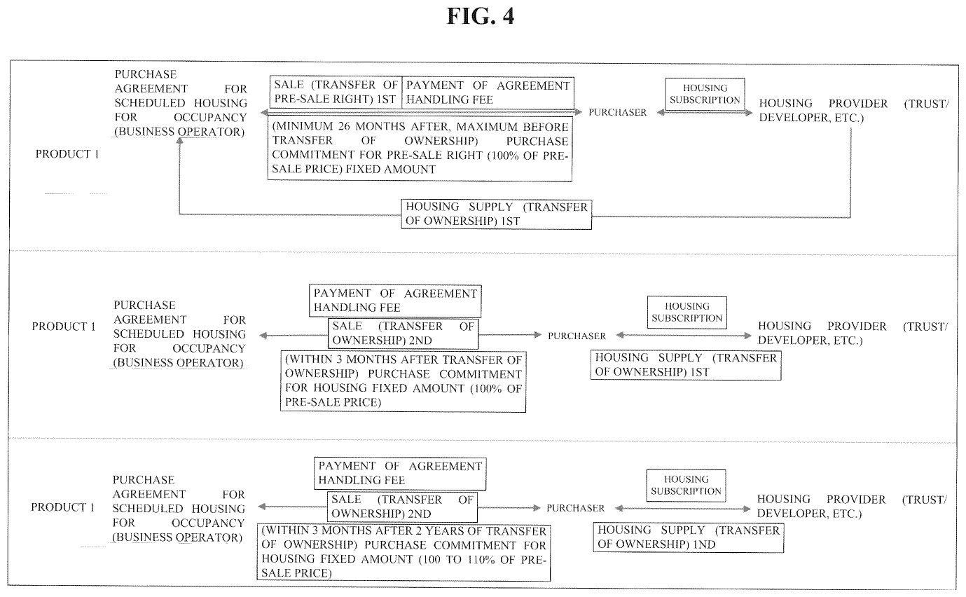

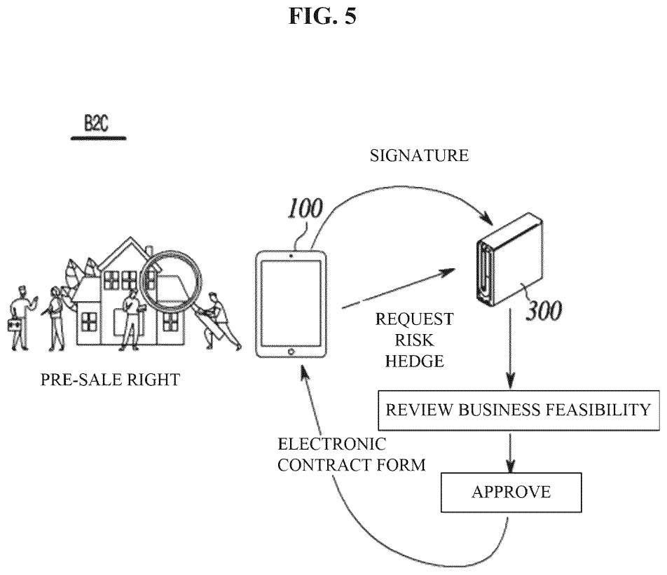

FIG. 3 is a flowchart illustrating a method of providing a risk hedge agreement service for real estate property within an unapproved business site to a user in various embodiments. FIG. 4 is a diagram illustrating exemplary types of risk hedge agreement products applicable to various embodiments. FIGS. 5 to 7 are diagrams illustrating a process (B2C) for providing a real estate risk hedge agreement service to a user in various embodiments.

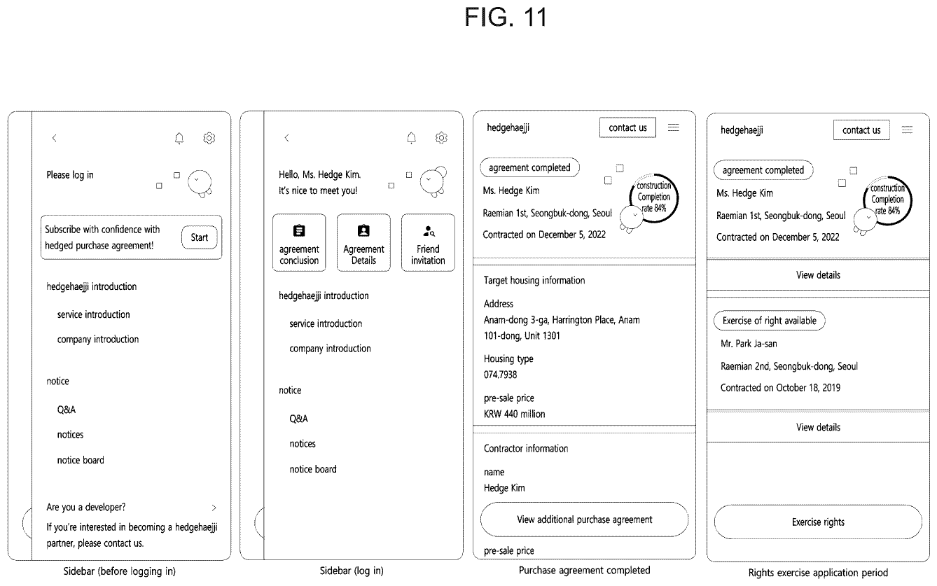

Referring to FIGS. 3 to 7, in operation S101, the server 300 may acquire a purchase request (or a risk hedge request for real estate property) for the risk hedge agreement product (e.g., Products 1 to 3 of FIG. 4) for real estate property from a user. For example, the server 300 may provide an application form for subscribing to the risk hedge agreement product via a UI (e.g., FIGS. 11 to 15) and may acquire a purchase request (or subscription request) for the risk hedge agreement product through the application form. Here, the real estate property may be a pre-sale right, which is the right to move into an apartment after completion, but is not limited thereto.

In operation S102, the server 300 may review the real estate property for which the purchase of the risk hedge agreement product has been requested, in response to the purchase request acquired through operation S101.

In various embodiments, the server 300 may derive business feasibility review results by performing a business feasibility review process of analyzing information regarding real estate property and real estate development projects being conducted at business sites including real estate property. However, the server 300 is not limited thereto. The server 300 may also receive business feasibility review results derived from analyzing the real estate development project being conducted at a specific business site from an external source and may perform a review of the real estate property for which the purchase of the risk hedge agreement product has been requested based on the uploaded business feasibility review results.

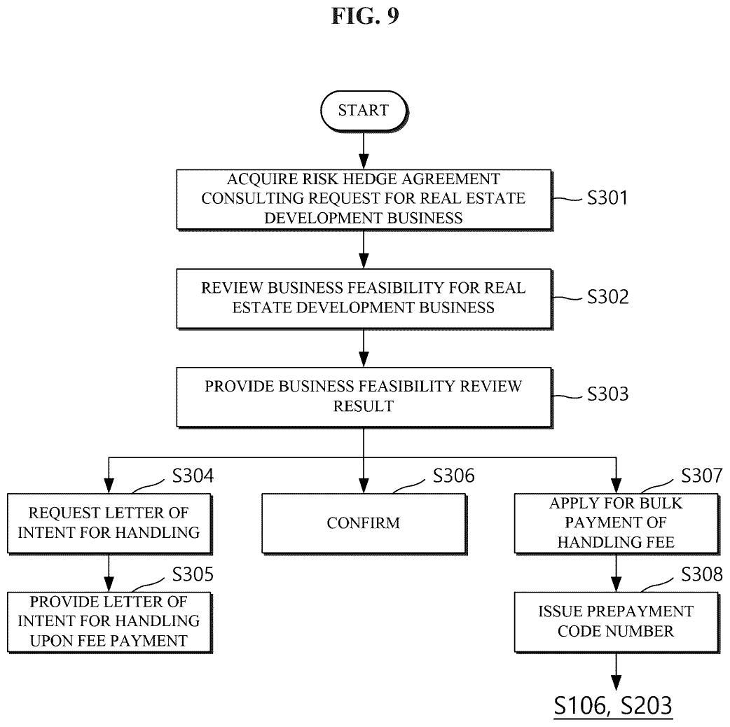

Here, a specific method of deriving business feasibility review results for real estate property and business sites including real estate property by performing a business feasibility review process for real estate property and business sites including real estate property will be described later with reference to FIG. 9.

In operation S103, the server 300 may determine approval for subscription to the risk hedge agreement product based on the business feasibility review results derived through operation S102.

In various embodiments, the server 300 may determine the number of eligible households or the agreed ratio for the risk hedge agreement product for the business site including real estate property based on the risk acceptance rate included in the business feasibility review results, and may approve or reject subscription to the risk hedge agreement product for the real estate property based on the eligible households or the agreed ratio.

For example, when the business feasibility review results for a specific business site containing 1,000 apartment units indicate a risk acceptance rate of 30%, the server 300 may determine the number of eligible households for the risk hedge agreement product to be 300 households, which is 30% of the 1,000 households. When the number of households subscribing to the risk hedge agreement product for the real estate property included in the business site is less than the number of eligible households for the business site, the server 300 may approve the subscription to the risk hedge agreement product for the real estate property.

Meanwhile, when the number of households subscribing to the risk hedge agreement product for the real estate property included in the business site is greater than the number of eligible households for the business site, the server 300 may reject the subscription to the risk hedge agreement product for the real estate property.

In operation S104, after performing operation S103, the server 300 may provide a notification informing the user of the rejection of the subscription to the risk hedge agreement product when the subscription to the risk hedge agreement product requested by the user is rejected.

In operation S105, when the server 300 approves the user's request for the risk hedge agreement product through operation S103, the server 300 may execute an electronic contract process of concluding the electronic contract for the risk hedge agreement product.

More specifically, when the user's request for the risk hedge agreement product is approved, the server 300 may provide the user with an electronic contract form for the risk hedge agreement product for the real estate property.

Thereafter, in response to providing the user with the electronic contract form, the server 300 may acquire signature information from the user and conclude the electronic contract for the risk hedge agreement product for the real estate property based on this information.

Meanwhile, the server 300 may perform a user authentication process to determine whether the user has entered their own signature or whether it is a forged signature. For example, the server 300 may transmit identification information acquired from the user terminal 100 to at least one public institution server for verification, perform identity verification based on at least one feature point in a facial image collected in real time from the user terminal 100, or, in some cases, perform user identity verification using a pre-established identity verification process (e.g., Naver identity verification, KakaoTalk identity verification, mobile phone identity verification, etc.).

In various embodiments, when the electronic contract of the risk hedge agreement product for the real estate property is concluded, the server 300 may issue an NFT corresponding to the electronic contract form. When the user does not exercise their rights under the concluded electronic contract, the server may terminate the electronic contract by burning the NFT corresponding to the electronic contract form.

In operation S106, when the electronic contract of the risk hedge agreement product for the real estate property is concluded through operation S105, the server 300 may provide the user with a payment process for the handling fee for the risk hedge agreement product and collect the handling fee from the user through the payment process.

In this case, the server 300 may determine the handling fee based on at least one indicator among the acquisition cost of the real estate property, market price, exercise price, remaining period until the expiration of the electronic contract, price volatility, and market conditions, but is not limited thereto. Here, the acquisition cost may refer to the acquisition price, i.e., the amount actually required for a user to purchase the real estate. This acquisition price may be calculated based on the acquisition tax.

Here, the user may pay the handling fee directly or through a prepayment method. For example, the user may directly pay the handling fee through any of the following payment methods: CMS (installment payment), account transfer (lump-sum payment), or card (lump-sum payment). Furthermore, the user may have the business operator prepay the handling fee by entering a prepayment code acquired from a business operator conducting the real estate development project at a business site including the real estate property.

In operation S107, the server 300 may determine whether a user who entered into an electronic contract for the risk hedge agreement product will exercise their rights after the mandatory commitment period under the electronic contract has elapsed, i.e., after the risk hedge agreement product expires. For example, when the server 300 acquires the user's intent to exercise their rights within a predetermined period after the mandatory commitment period under the electronic contract has elapsed, the server 300 may determine that the user is exercising their rights under the electronic contract. When the server 300 acquires the user's intent to exercise their rights within the predetermined period or fails to acquire separate feedback, the server 300 may determine that the user is not exercising their rights under the electronic contract.

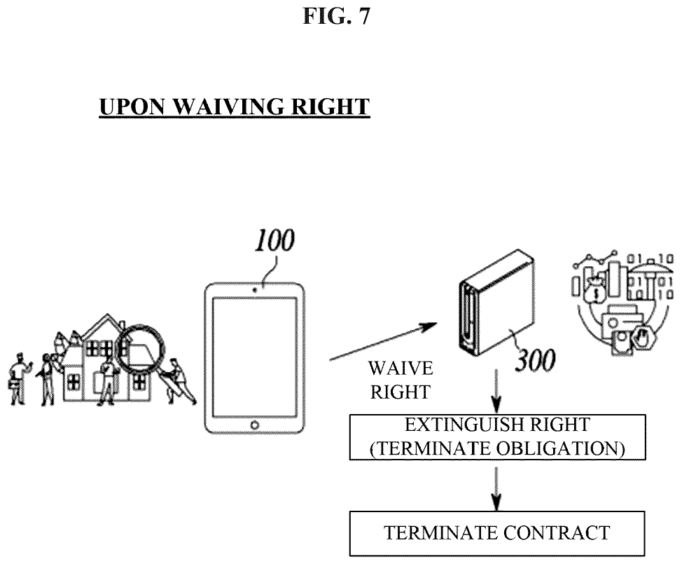

In operation S108, as illustrated in FIG. 7, when the server 300 determines that the user has not exercised their rights under the electronic contract within a predetermined period after the mandatory commitment period under the electronic contract has expired, the server 300 may terminate the concluded electronic contract with the user, thereby terminating the contract based on the electronic contract form corresponding to the electronic contract.

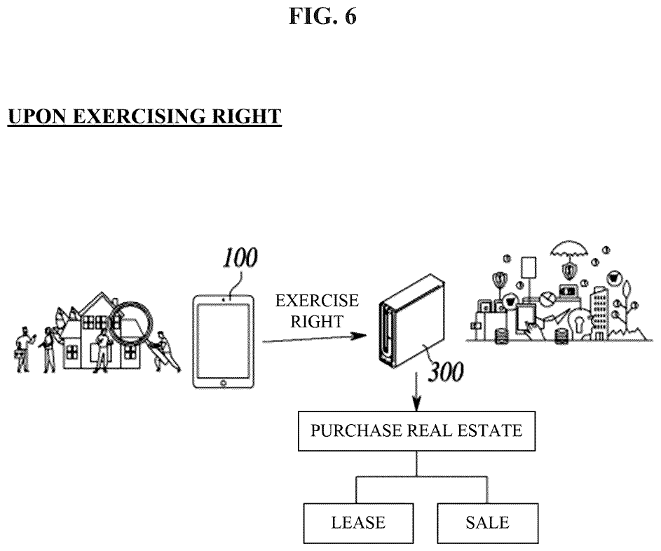

In operation S109, as illustrated in FIG. 6, when the server 300 determines that the user has exercised their rights to the electronic contract within a predetermined period after the mandatory commitment period for the electronic contract expires, following operation S107, the server 300 performs a real estate purchase contract process, thereby purchasing the user's real estate property at a pre-determined exercise price.

Here, since the real estate property is a pre-sale right, the pre-determined exercise price for the real estate property may be the pre-sale price of the real estate property. However, the exercise price is not limited thereto. The exercise price may be determined in consideration of factors such as the property's transportation convenience, view, floor number (whether it is a royal floor), address, surrounding market prices, school districts, the property's name value at the time of construction, and indicators representing overall real estate market trends. For example, even when the real estate properties are located within the same business site, the exercise price for a royal floor real estate property may be set higher than for a non-royal floor real estate property.

In other words, when the price of the real estate property of the risk hedge agreement product subscription is predicted to rise above a predetermined exercise price or is predicted to continue to rise, the user may maintain ownership of the real estate property even when they incur a loss equivalent to the handling fee paid in the process of subscribing to the risk hedge agreement product. When the price of the real estate property of the risk hedge agreement product subscription is predicted to fall below the predetermined exercise price or is predicted to continue to decline, the user may avoid the risk of real estate price fluctuations by exercising their rights under the risk hedge agreement product and selling the real estate property at the predetermined exercise price.

In various embodiments, when the user wishes to exercise their rights under the electronic contract after a predetermined period of time has elapsed following the expiration of the mandatory commitment period under the electronic contract, the server 300 performs a real estate purchase contract process of purchasing the user's real estate property. However, since the user wishes to exercise their rights after a predetermined period of time during which they may exercise their rights has elapsed, the server 300 may purchase the real estate property at a price that is a predetermined percentage lower than the predetermined exercise price.

In this case, the predetermined ratio may be determined based on the length of time from the expiration of the predetermined period during which the user may exercise their rights to the time the user wishes to exercise their rights again, but is not limited thereto.

In various embodiments, when a user attempts to exercise their rights under an electronic contract within a predetermined period after the expiration of the mandatory commitment period for the electronic contract, but then withdraws their rights after the predetermined period has elapsed, the server 300 may charge the user an additional fee corresponding to the withdrawal of their rights. When the user pays the additional fee, the server may terminate the concluded electronic contract with the user, thereby terminating the contract based on the electronic contract form corresponding to the electronic contract.

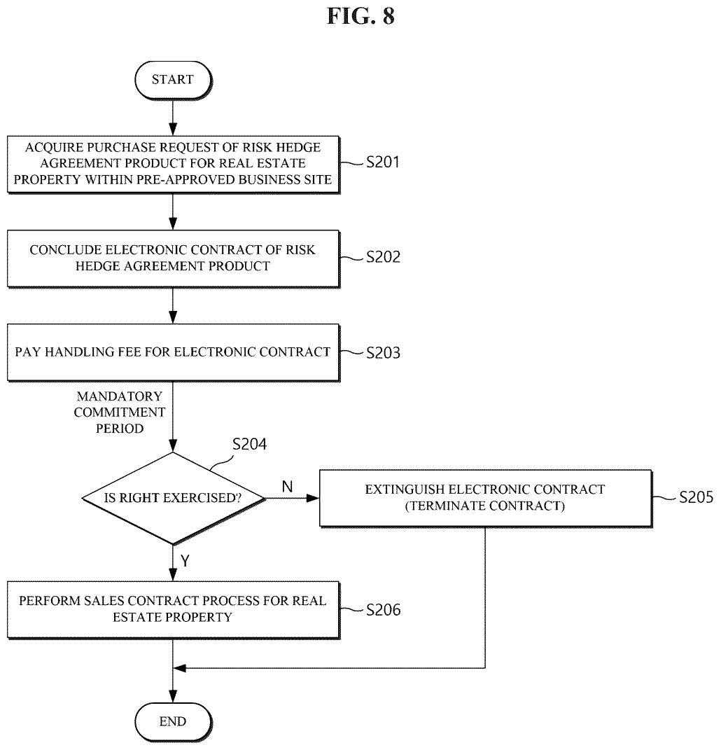

FIG. 8 is a flowchart illustrating a method of providing a risk hedge agreement service for real estate property within a previously approved business site to a user in various embodiments.

Referring to FIG. 8, in operation S201, the server 300 may acquire a purchase request from a user for the risk hedge agreement product for the real estate property within a previously approved business site. For example, the server 300 may provide a business site list including information on previously approved business sites via a UI (e.g., FIGS. 11 to 15) and may select a business site to subscribe to the risk hedge agreement product and the real estate property included within the business site from among multiple business sites included in the business site list.

In operation S202, the server 300 may conclude the electronic contract for the risk hedge agreement product for the real estate property selected through operation S201. Here, the electronic contract for the risk hedge agreement product for the real estate property concluded by the server 300 may be implemented in a form identical or similar to operation S105 of FIG. 3, but is not limited thereto.

In operation S203, when the electronic contract for the risk hedge agreement product for the real estate property is concluded through operation S202, the server 300 may provide the user with a payment process of paying the handling fee for the risk hedge agreement product and collect the handling fee from the user through the payment process. The handling fee payment operation performed by the server 300 may be implemented in a form identical or similar to operation S106 of FIG. 3, but is not limited thereto.

In operation S204, the server 300 may determine whether the user who concludes the electronic contract for the risk hedge agreement product exercises their rights after the mandatory commitment period under the electronic contract has elapsed, i.e., after the risk hedge agreement product expires. The operation performed by the server 300 to determine whether the user exercises their rights may be implemented in a form identical or similar to operation S107 of FIG. 3, but is not limited thereto.

In operation S205, when the server 300 determines that the user has not exercised their rights to the electronic contract within a predetermined period after the mandatory commitment period has expired, as determined through operation S204, the server 300 terminates the concluded electronic contract with the user, thereby terminating the contract based on the electronic contract form corresponding to the electronic contract.

In operation S206, when the server 300 determines that the user has exercised their rights to the electronic contract within a predetermined period after the mandatory commitment period expires, as determined through operation S204, the server 300 performs a real estate purchase contract process of purchasing the user's real estate property at a predetermined exercise price.

That is, when the server 300 receives a request from a user to purchase the risk hedge agreement product for the real estate property within the previously approved business site, the server 300 immediately initiates the purchase process for the risk hedge agreement product for the real estate property without a separate business feasibility review process for the business site, thereby enabling faster agreement product subscription.

In various embodiments, when a concluded electronic contract with a user includes a lease option, and the user wishes to enter into a lease agreement for the real estate property after exercising their rights under the electronic contract, the server 300 may provide the user with a predetermined advantage regarding the lease agreement based on the lease option included in the electronic contract.

More specifically, when purchasing and subscribing to the risk hedge agreement product for a specific real estate property, the user may add a lease option by paying an additional fee in addition to the handling fee paid for purchasing the risk hedge agreement product.

Here, the lease option is an option activated when entering into a lease agreement for the real estate property. For example, it may be an option that reduces the monthly lease, deposit, management fee, etc., by a predetermined percentage. The properties of the lease option may be determined based on the additional fee paid, or an additional fee corresponding to the lease option may be charged based on the properties of the lease option.

For example, the server 300 may add an option to reduce any one of the deposit, monthly lease, and management fee by a first rate when a user wishing to add a tenant option pays a first-rate additional fee. Furthermore, the server 300 may add an option to reduce two of the deposit, monthly lease, and management fee by a second rate greater than the first rate when the user wishing to add a tenant option pays a second-rate additional fee greater than the first-rate additional fee. Furthermore, the server 300 may add an option to reduce all items by a third rate greater than the second rate when the user wishing to add a lease option pays a third-rate additional fee greater than the second-rate additional fee.

As another example, the server 300 may receive a predetermined fee from a user wishing to add a tenant option and determine the number of items subject to reduction and the reduction rate based on the amount of the fee paid. However, the present disclosure is not limited thereto.

Thereafter, when the server 300 determines that the user has exercised their rights under the electronic contract within a predetermined period after the expiration of the mandatory commitment period under the user's electronic contract, the server 300 may perform a real estate purchase contract process of purchasing the user's real estate property at a predetermined exercise price.

In this case, when the user wishes to enter into a lease agreement for the real estate property, the server 300 may reduce at least one of the deposit, monthly lease, and management fee by a predetermined percentage based on the lease options included in the electronic contract. While the server 300 describes applying the lease options when entering into a lease agreement for a real estate property for which the user has subscribed to the risk hedge agreement product, the server 300 is not limited thereto and may be applied to any real estate property for which a lease agreement may be entered into through the real estate lease service provided by the server 300.

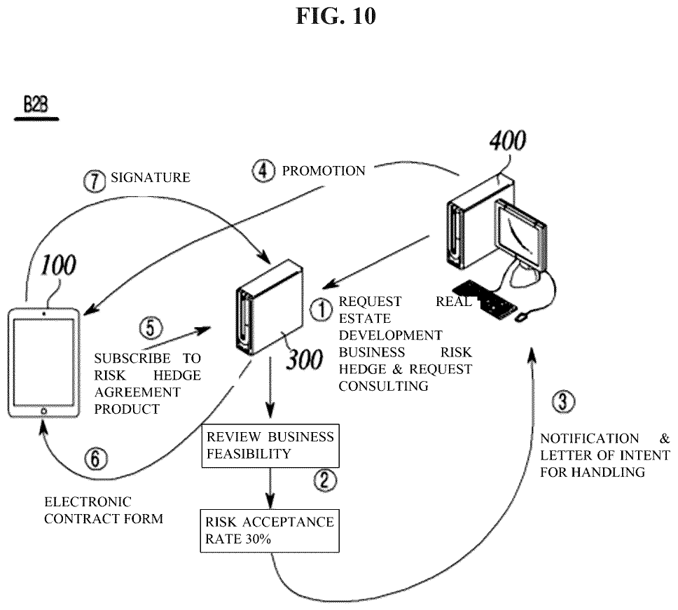

FIG. 9 is a flowchart illustrating a method of providing a real estate risk hedge agreement service to a company in various embodiments. FIG. 10 is a diagram illustrating a process (B2B) for providing real estate risk hedge agreement services to a company in various embodiments.

Referring to FIGS. 9 and 10, in operation S301, the server 300 may acquire a consulting request from the business operator terminal 400 regarding a real estate development business being performed at a specific business site. For example, the server 300 may provide the UI (e.g., FIGS. 11 to 15) to the business operator terminal 400 and acquire the consulting request through the UI. Here, consulting on a real estate development business involves not only deriving and providing information on the degree or likelihood of success of the development project, but also, based on such information, determining and providing information on whether the real estate risk hedge agreement services may be provided, and to what extent or in what rate such services may be provided. In other words, the consulting covers both the evaluation of the success likelihood of the real estate development business and the consultation on the risk hedge agreement for the corresponding business site.

In operation S302, the server 300 may derive a business feasibility result by performing a business feasibility process for the real estate development business being performed at the specific business site based on the consulting request acquired through operation S301.

Here, the business feasibility method (or business feasibility evaluation method) performed by the server 300 is as follows.

The server 300 may derive key influencing factors of the real estate development business through factor analysis of risk factors affecting the business and may quantitatively evaluate the degree of success of the business based on the derived key influencing factors. By selectively utilizing various risk factor evaluation methodologies, a fuzzy-analytic hierarchy process (fuzzy-AHP) analysis may be performed on the key success influencing factors derived through the factor analysis, and, based on the factor analysis, may construct a success prediction model that quantifies the risk factors of the real estate development business and predicts the likelihood of success. Here, the factor analysis is a statistical method that processes a large number or large amount of data to extract a small number of theoretically or content-wise meaningful variables. When the number of variables being analyzed is large, it may refer to a statistical analysis method that utilizes the correlation among the variables to extract common variables inherent in the variables and describes the characteristics of all the data.

Here, the evaluation fields of the influencing factors may include project participants, development plans, target sites, project processes, financial performance, etc. The evaluation items of the influencing factors may include, but are not limited to, the capabilities of a developer, the capabilities of a construction company, the capabilities of a financial institution, location analysis, development concepts and target sites, post-development value evaluation and operation, construction risk management plans, marketing plans, site acquisition and contract details, site evaluation progress, construction, approvals and permits, contracts, business feasibility analysis, profit and loss, and dividend plans, etc.

In various embodiments, when there are overlapping or correlated factors among the influencing factors of the real estate development business, the server 300 may perform a factor analysis on factors that are mutually overlapping or correlated, and, based on the results, may quantify the influencing factors by grouping similar influencing factors to reconstruct multiple influencing elements into a smaller number of meaningful groups.

In various embodiments, the server 300 may use the fuzzy-AHP technique to quantitatively determine the relative importance of influencing factors extracted through the factor analysis. Here, the fuzzy-AHP technique is an alternative designed to compensate for the shortcomings of the AHP technique, which tends to lose accuracy when evaluating a large number of alternatives in various decision-making situations.

In various embodiments, the server 300 may organize the survey data using the triangular fuzzy function to calculate the weights of each item and determine the risk acceptance rate based on the calculated weights. However, the server is not limited thereto, and various methods of determining a risk acceptance rate may be applied. Here, the risk acceptance rate may refer to the ratio of the number of households eligible to subscribe to the risk hedge agreement product to the total number of households supplied in a specific business site, but is not limited thereto.

In various embodiments, the server 300 may set the number of subscribers, contract ratio, handling fee rate, appropriate contract price, etc., for the risk hedge agreement product for the specific business site based on the risk acceptance rate.

Here, the server 300 is described as determining the number of subscribers (eligible households for subscription) or the contract ratio based on the risk acceptance rate, but is not limited thereto. The risk acceptance rate for the specific business site may be determined based on the number of subscribers (eligible households for subscription) or the contract ratio for that business site.

More specifically, the server 300 first individually evaluates each of the multiple households included in the specific business site based on predefined evaluation areas and evaluation items, thereby individually determining whether each household is eligible for the risk hedge agreement product.

Subsequently, the server 300 may calculate the ratio of the number of households deemed eligible for the risk hedge agreement product to the number of jeonse households included in the specific business site and determine the risk acceptance rate for the specific business site based on the calculated ratio.

That is, the server 300 may individually examine whether each of the 1,000 households may subscribe to a risk hedge agreement product for a specific business site including 1,000 households, and when it is determined that 300 households out of the 1,000 households may subscribe to a risk hedge agreement product based on the examination results, the server may determine the risk acceptance rate for the specific business site to be 30%.

In operation S303, the server 300 may provide the business feasibility result derived through operation S302 to the business operator terminal 400 (or user terminal 100). For example, the server 300 may generate and provide the business feasibility result for a specific business site in the form of a report but is not limited thereto.

In various embodiments, when the server 300 receives a request for a letter of intent for handling based on the business feasibility result from the business site (S304), the server 300 may receive a predetermined fee from the user and provide the letter of intent for handling accordingly (S305). Here, the letter of intent for handling is a document that includes a statement that the business operator agrees to commit X % at the project site for which a review has been requested.

Meanwhile, in various embodiments, when the server 300 fails to acquire separate feedback in response to providing the business feasibility result to the business operator or acquires user input indicating the confirmation of the business feasibility result, the server 300 may terminate the business feasibility process for the specific business location (S306).

In various embodiments, when the server 300 receives the lump-sum payment request for the handling fee from the business operator in response to providing the business feasibility result to the business operator (S307), the server may issue a code number corresponding to the handling fee prepayment to a business operator. When a business operator prepays the handling fee, the electronic contract for the risk hedge agreement product for real estate property within a specific business site is concluded with the user who requested the purchase, but that handling fee may be processed in the form of a contract for a third party to whom the business operator makes the payment.

In the contract for the third party, a promisor is the business operator of the business operator terminal 400, who serves as the creditor receiving the promise of performance to the third part, a promisee is a platform of the present invention, which bears the obligation to provide the benefit to the third party; and a beneficiary is a third party who acquires the right to directly receive the benefit, i.e., the user of the user terminal 100. When the business operator prepays the handling fee, the code number corresponding to the prepayment is issued. When a user applies for a sale under the business operator's business, payment may be made by simply entering the pre-issued code number after signing the electronic contract.

Typically, the real estate development business procedure varies somewhat depending on the type, scale, and financial structure of the business, but may be broadly divided into three stages: \textcircled{1} the business concept and planning stage, \textcircled{2} the execution stage (land acquisition, financial structure establishment, pre-sale, construction), and \textcircled{3} the settlement and management stage.

Individuals (users) seeking to acquire presale rights face difficulties in decision-making because it is challenging to predict whether the value of these presale rights will decline or rise in the future. The business operator may promote the pre-sale by providing the option for the risk hedge agreement product related to pre-sale rights during the execution stage \textcircled{2} of the real estate development business.

In addition, the business operator may promote, based on the risk acceptance rate derived from the business feasibility result, the number of households eligible to select the risk hedge agreement product option when the subscription to the risk hedge agreement product is possible only for a portion of households relative to the total number of households, thereby enabling prospective buyers seeking pre-sale rights to perform decision-making more quickly.

The method of providing a real estate risk hedge agreement service according to various embodiments of the present invention provides a risk hedge agreement product as a means of avoiding or transferring risks associated with future real estate price fluctuations. In this case, as shown in Table 1 below, the platform operated by the server 300 is a purchase agreement business operator, i.e., a rights assignor that sells the right to purchase at an agreed price even if there are price fluctuations of real estate in the future, and a user, who is a customer using the platform of the present invention, is a rights assignee that purchases the right to purchase at the agreed price.

TABLE 1

| | Rights assignor (platform) | Rights assignee (user) |
|---|---|---|
| Definition | Entity that issues rights | Right holder |
| | Selling rights for a fee (handling fee, | By paying a certain |
| | premium) from the rights assignor | consideration (handling fee or |
| | The rights purchaser is granted rights | premium) to the rights assignor, |
| | according to the terms of the contract, and the | the rights purchaser receives |
| | purchaser of rights is obligated to respond | the right to exercise the rights. |
| | when the purchaser attempts to exercise the | |
| | rights. | |
| Transactional | Granting of rights | Receipt of rights |
| relationship | | |
| Consideration | Receipt of handling fee and premium | Payment of handling fee and |
| | | premium |

The key functions of futures and derivative markets include hedging, speculation, price discovery, and risk management. Risk may be divided into firm-specific risk, which may be reduced through diversified investments, and market risk, which cannot be reduced. Market risk, which may not be reduced through diversified investments or internal risk management techniques, requires external financing techniques, such as derivatives or futures markets.

Considering this, the method of providing the real estate risk hedge agreement service, according to various embodiments of the present disclosure, provides the risk hedge agreement product and allows users who subscribe to the risk hedge agreement product to hedge the risks arising from real estate price fluctuations.

A covered call is used when the real estate price is expected to rise above the pre-sale price, but not by a significant amount. Selling a call option (short) based on the pre-sale price generates a corresponding profit (call premium). However, this yields upside potential when the underlying asset, the apartment, rises above the pre-sale price.

According to various embodiments of the present disclosure, the method of providing the real estate risk hedge agreement service grants users the right to sell at the pre-sale price, and when the price rises, forgo the handling fee in exchange for profit from the upside potential.

The above-described method of providing a real estate risk hedge agreement service is described with reference to the flow chart illustrated in the drawing. For a simple description, the method of method of providing a real estate risk hedge agreement service has been described by showing a series of blocks, but the present disclosure is not limited to the order of the blocks, and some blocks may be performed in an order different from that shown and performed in the present specification, or may be performed concurrently. In addition, new blocks not described in the present specification and drawings may be added, or some blocks may be deleted or changed.

According to various embodiments of the present disclosure, by executing an electronic contract of a risk hedge agreement product for a real estate property upon a user's request, extinguishing the electronic contract based on whether the user exercises their rights under the electronic contract so that the user maintains ownership of the real estate property, or allowing the user to sell the real estate property at a predetermined fixed price, it is possible to avoid risks arising from real estate price fluctuations.

In particular, according to various embodiments of the present disclosure, by allowing the user to either maintain the ownership of the real estate property or sell the real estate property in advance at the fixed price depending on whether or not the user exercises their rights under the electronic contract of the risk hedge agreement product, it is possible to eliminate risks such as uncertainty and illiquidity in real estate prices. Consequently, it becomes possible to relieve the sense of burden and anxiety that the user may experience when purchasing or subscribing to real estate.

The effects of the present disclosure are not limited to the above-described effects, and other effects that are not mentioned may be obviously understood by those skilled in the art from the following description.

Although exemplary embodiments of the present disclosure have been described with reference to the accompanying drawings, those skilled in the art to which the present disclosure belongs will appreciate that various modifications and alterations may be made without departing from the spirit or essential features of the present disclosure. Therefore, it is to be understood that the embodiments described above are illustrative rather than being restrictive in all aspects.

What is claimed is:

1. A method of providing a real estate risk hedge agreement service, performed by a server, the method comprising:
acquiring a purchase request for a risk hedge agreement product for a real estate property from a user;
concluding an electronic contract for the risk hedge agreement product by performing an electronic contract process in response to the acquired purchase request; and
extinguishing the concluded electronic contract or performing a sales contract process for the real estate property based on whether the user exercises their rights under the concluded electronic contract.

2. The method of claim 1, wherein the concluding of the electronic contract includes:
performing a feasibility review process of analyzing information regarding the real estate property and a real estate development project being performed at a business site including the real estate property;
determining approval for subscription to the risk hedge agreement product for the real estate property based on business feasibility review results derived from the performed business feasibility review process;
when the subscription to the risk hedge agreement product for the real estate property is approved, providing the user with an electronic contract form to execute a contract for the risk hedge agreement product for the real estate property; and
concluding the electronic contract for the risk hedge agreement product for the real estate property based on signature information acquired from the user in response to the provided electronic contract form.

3. The method of claim 2, wherein the performing of the feasibility review process includes:
determining whether each of a plurality of households included in a specific business site is eligible to subscribe to the risk hedge agreement product by screening each of the plurality of households based on predefined evaluation fields and evaluation items; and
calculating a ratio of the number of households determined to be eligible to subscribe to the risk hedge agreement product to the number of the plurality of households and determining a risk acceptance rate for the specific business site based on the calculated ratio.

4. The method of claim 2, wherein the performing of the business feasibility review process includes calculating a risk acceptance rate of the business site including the real estate property by performing a factor analysis of the real estate development project for the business site including the real estate property based on the predefined evaluation fields and evaluation items, and
the determining of the approval for subscription to the risk hedge agreement product includes:
determining an eligible household or an agreed ratio of the risk hedge agreement product for the business site including the real estate property based on the calculated risk acceptance rate; and
approving or rejecting the subscription to the risk hedge agreement product for the real estate property based on the determined eligible household or agreed ratio.

5. The method of claim 2, wherein the concluding of the electronic contract of the risk hedge agreement product for the real estate property includes, when acquiring the signature information from the user in response to the provided electronic contract form, providing the user with a payment process of paying a handling fee for the risk hedge agreement product, and the handling fee is determined based on an indicator corresponding to at least one of an acquisition cost, a market price, an exercise price of the real estate property, a remaining period until the expiration of the concluded electronic contract, price volatility, and market conditions.

6. The method of claim 1, wherein the concluding of the electronic contract includes:
when the business site including the real estate property is a previously approved business site, providing the user with an electronic contract form for contract of the risk hedge agreement product for the real estate property; and
when the business site including the real estate property is a new business site, providing the user with the electronic contract form for the contract of the risk hedge agreement product for the real estate property only when the subscription to the risk hedge agreement product for the real estate property is approved through a business feasibility review process.

7. The method of claim 1, wherein the extinguishing of the concluded electronic contract or the performing of the sales contract process for the real estate property includes performing a real estate purchase contract process of purchasing the real estate property at a predetermined exercise price when the user exercises their rights regarding the concluded electronic contract within a predetermined period after an expiration of a mandatory commitment period under the concluded electronic contract.

8. The method of claim 1, wherein the extinguishing of the concluded electronic contract or the performing of the sales contract process for the real estate property includes extinguishing the concluded electronic contract and terminating the contract under the electronic contract corresponding to the concluded electronic contract when the user does not exercise their rights to the concluded electronic contract within a predetermined period after an expiration of a mandatory commitment period under the concluded electronic contract.

9. The method of claim 1, further comprising, when a business operator requests risk hedge agreement consulting for a real estate development project performed at a specific business site, performing a business feasibility review process of deriving business feasibility review results including a risk acceptance rate for the real estate development project performed at the specific business site, the risk acceptance rate being a ratio of the number of eligible households of the risk hedge agreement product to a total number of households supplied at the specific business site, and providing the derived business feasibility review results to the business operator or the user.

10. A server for performing a method of providing a real estate risk hedge agreement service, the server comprising:
a processor;
a network interface;
a memory; and
a computer program loaded into the memory and executed by the processor,
wherein the computer program includes:
an instruction to acquire a purchase request for a risk hedge agreement product for a real estate property from a user;
an instruction to conclude an electronic contract for the risk hedge agreement product by performing an electronic contract process in response to the acquired purchase request; and
an instruction to extinguish the concluded electronic contract or perform a sales contract process for the real estate property based on whether the user exercises their rights under the concluded electronic contract.

11. A computer program stored in a computer-readable recording medium, which is coupled with a server to execute a method of providing a real estate risk hedge agreement service, wherein the method includes:
acquiring a purchase request for a risk hedge agreement product for a real estate property from a user,
concluding an electronic contract for the risk hedge agreement product by performing an electronic contract process in response to the acquired purchase request; and
extinguishing the concluded electronic contract or performing a sales contract process for the real estate property based on whether the user exercises their rights under the concluded electronic contract.
